(19) United States
(12) Patent Application Publication
(10) Pub. No.: US 2020/0090152 A1
(43) Pub. Date: Mar. 19, 2020

(54) METHOD AND SYSTEM FOR PROCESSING TRANSACTIONS

(71) Applicant: MASTERCARD INTERNATIONAL INCORPORATED, Purchase, NY (US)

(72) Inventors: Manish Kumar, Gurgaon (IN); Vikas Bishnoi, Jodhpur (IN); Ankur Mehta, Faridabad (IN)

(73) Assignee: MASTERCARD INTERNATIONAL INCORPORATED, Purchase, NY (US)

(21) Appl. No.: 16/574,958

(22) Filed: Sep. 18, 2019

(30) Foreign Application Priority Data
Sep. 19, 2018 (SG) 10201808124W

(51) Int. Cl. G06Q 20/20; G06K 19/06; G06K 7/14

(52) U.S. Cl. CPC G06Q 20/20; G06K 7/1417; G06K 19/06037

(57) ABSTRACT

A method for processing transactions includes receiving transaction details of a transaction performed by a payer for making a purchase from a first payee. The transaction details include a first payee identifier of the first payee and a purchase amount of the purchase. The first payee identifier is used to access one or more databases for retrieving account details of a second payee and a proportion value of the payment amount. Based on the proportion value, a first amount is withheld for the second payee from an account of the payer. The first amount is then deposited in an account of the second payee linked to the retrieved account details and a certificate of successful deposit of the first amount is communicated to the payer and the first payee.

### FIELD OF THE INVENTION

The present invention relates to a method and a system for conducting transactions, and more particularly, to a method and a system for processing electronic transactions.

### BACKGROUND

Every country has laid down various tax mandates for merchants and customers throughout the country to comply with. For example, every time a merchant purchases goods from a vendor, the merchant is required to withhold a specific amount from a payment amount as tax and deposit the withheld amount in an account of a tax collection authority. The merchant deposits the tax under a taxpayer identification number (TIN) of the vendor. When the tax is deposited, a certificate is generated and communicated to the vendor, which can be used as a proof by the vendor at the time of tax filing.

However, some merchants do not report all the transactions made with the vendors, either intentionally or unintentionally. By not reporting all the transactions, such merchants avoid declaring their actual gross income in the income tax returns, thus keeping the tax on unreported transactions for their own benefits. Moreover, if a merchant does not deposit the tax for a purchase made from a vendor, the vendor might face problems at the time of tax filing. On the other hand, a merchant may purchase goods from multiple vendors. Thus, depositing the tax for each vendor, generating certificates for every transaction performed with each vendor, and communicating the certificates to the respective vendors is a tedious and time-consuming activity for the merchant.

In light of the foregoing, there exists a need for a solution that ensures a smooth deposit of withheld amounts for every purchase that merchants and customers make and at the same time, simplifies the process of deposit of the withheld amounts for the merchants and the customers.

### SUMMARY

In an embodiment of the present invention, a method for processing transactions is provided. Transaction details of a transaction initiated by a payer are received by a payment interface. The transaction details include a payee identifier of a first payee and a payment amount. One or more databases are accessed by the payment interface based on the transaction details to retrieve account details of a second payee and a proportion value of the payment amount that is to be withheld for the second payee. Withholding of a first part of the payment amount is initiated by the payment interface, based on the retrieved proportion value. Deposit of the first part of the payment amount is initiated by the payment interface, such that the first part of the payment amount is deposited in a first account of the second payee that is linked to the retrieved account details.

In another embodiment of the present invention, a system for processing transactions is provided. The system includes a payment interface that receives transaction details of a transaction initiated by a payer. The transaction details include a payee identifier of a first payee and a payment amount. The payment interface accesses one or more databases based on the transaction details to retrieve account details of a second payee and a proportion value of the payment amount that is to be withheld for the second payee. The payment interface initiates withholding of a first part of the payment amount, based on the retrieved proportion value. The payment interface further initiates deposit of the first part of the payment amount, such that the first part of the payment amount is deposited in a first account of the second payee that is linked to the retrieved account information.

In yet another embodiment of the present invention, a method for processing business-to-business transactions is provided. Transaction details of a transaction initiated by a merchant are received by a payment interface. The transaction details include a vendor identifier of a vendor and a payment amount. A first look-up table is accessed by the payment interface based on the vendor identifier to retrieve a proportion value of the payment amount that is to be withheld for a tax collection authority. Withholding of a first amount from a merchant account of the merchant is initiated by the payment interface, based on the retrieved proportion value. One of the first look-up table or a second look-up table is accessed by the payment interface to retrieve account details of the tax collection authority for depositing the first amount. Deposit of the first amount and the payment amount in first and second accounts, respectively, is initiated by the payment interface. The first account corresponds to the tax collection authority and is linked to the retrieved account details, and the second account corresponds to the vendor.

### BRIEF DESCRIPTION OF THE DRAWINGS

The accompanying drawings illustrate various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements, and in which:

FIG. 1 is a block diagram that illustrates a communication environment for processing transactions, in accordance with an embodiment of the present invention;

FIG. 2 is a block diagram that illustrates a payment interface of FIG. 1 for processing transactions, in accordance with an embodiment of the present invention;

FIGS. 3A and 3B, collectively represent a process flow diagram to illustrate an exemplary scenario for processing transactions that are inclusive of tax by using the payment interface of FIG. 2, in accordance with an embodiment of the present invention;

FIGS. 4A and 4B, collectively represent a process flow diagram to illustrate an exemplary scenario for processing transactions that are exclusive of tax by using the payment interface of FIG. 2, in accordance with an embodiment of the present invention;

FIG. 5 is a block diagram that illustrates an exemplary look-up table stored in a database server of FIG. 1, in accordance with an embodiment of the present invention;

FIGS. 6A, 6B, and 6C, collectively represent a flow chart that illustrates a method for processing transactions, in accordance with an embodiment of the present invention;

FIG. 7 represents a high-level flow chart that illustrates a method for processing transactions that are inclusive of tax, in accordance with an embodiment of the present invention;

FIG. 8 represents a high-level flow chart that illustrates a method for processing business-to-business transactions that are exclusive of tax, in accordance with an embodiment of the present invention; and

FIG. 9 represents a block diagram that illustrates system architecture of a computer system, in accordance with an embodiment of the present invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

A payer makes a purchase from a first payee and performs a transaction of a purchase amount corresponding to the purchase. A payment interface receives transaction details of the transaction. The transaction details include a first payee identifier and the payment amount. Based on the first payee identifier, the payment interface accesses a first database (for example, a look-up table or a ledger) to retrieve a proportion value of the payment amount that is to be withheld for a second payee. The payment interface initiates withholding of a first part of the payment amount (i.e., a withhold amount) based on the retrieved proportion value. The payment interface further uses the first payee identifier to access one of the first look-up table or a second look-up table to retrieve account details of the second payee for depositing the first part of the payment amount. The payment interface initiates deposit of the first part of the payment amount and remaining part of the payment amount in first and second accounts, such that the first account is of the second payee and is linked to the retrieved account details, and the second account is of the first payee. The payment interface further communicates certificates to the payer and the first and second payees to indicate successful deposit of the first part of the payment amount and remaining part of the payment amount in first and second accounts, respectively. In another scenario, when the payment amount is exclusive of the withhold amount, the payment interface initiates deposit of the withhold amount and the payment amount in the first and second accounts, respectively.

Since the withhold amount is automatically deposited in an account of one or more concerned entities (such as the second payee), the payer is saved from the hassle of manually initiating the deposit of the withhold amount for every purchase she makes. Further, the certificates indicating successful deposit of the withhold amount is communicated to the payer and other concerned authorities. In doing so, a constant check is kept on all electronic transactions performed by merchants or customers, and hence withhold amounts associated with purchases are paid to concerned authorities without any hassle.

Server is a physical or cloud data processing system on which a server program runs. A server may be implemented in hardware or software, or a combination thereof. In one embodiment, the server is implemented as a computer program that is executed on programmable computers, such as personal computers, laptops, or a network of computer systems. The server may correspond to a merchant server, an acquirer server, a payment network server, a payment interface server, or an issuer server.

Payer is an individual, who performs a transaction for a purchase of products and/or services. In a business to consumer (B2C) scenario, the payer is a customer who purchases products and/or services in exchange of payments from merchants. In a business to business (B2B) scenario, the payer is a merchant who purchases products and/or services in exchange of payments from another merchant (referred to as vendors).

First payee is a direct payee that derives direct benefit from a purchase made by a payer. In a B2C scenario, the first payee is a merchant who offers various products and/or services in exchange of payments to customers. In a B2B scenario, the first payee is a vendor who offers products and/or services in exchange of payments from merchants. When the payer performs a transaction to purchase a product or pay for a service offered by the first payee, the payer is required to withhold a specific proportion of a purchase amount as tax against a taxpayer identification number (TIN) of the first payee.

Second payee is an intermediary payee that derives indirect benefit from a purchase made by a payer. For example, the second payee is a tax collection authority. When the payer performs a transaction to purchase a product or pay for a service offered by a first payee, the second payee is subject to receiving a specific proportion of a purchase amount against the TIN of the first payee.

Issuer is a financial institution, where accounts of several payers are established and maintained. The issuer ensures payment for authorized transactions in accordance with various payment network regulations and local legislation.

Payment networks, such as those operated by Mastercard, process transactions between acquirers and issuers. Processing by a payment network includes the steps of authorization, clearing, and settlement.

Payment modes refer to payment means used by users for performing transactions, such as deposits and withdrawals, credit transfers, purchase payments, and the like. Examples of payment modes include transaction cards, financial accounts, digital wallets, and the like.

Payment interface is an entity that processes transactions for various purchases. The payment interface automatically initiates a deposit of withhold amount in an account of an intermediary payee for every purchase made by a payer. For depositing the withhold amount, the payment interface accesses one or more databases to determine a share the intermediary payee corresponding to the purchase and account details of the intermediary payee. The payment interface initiates withholding of the withhold amount based on the share of the intermediary payee. The withhold amount is then deposited in an account that is linked to the retrieved account details of the intermediary payee.

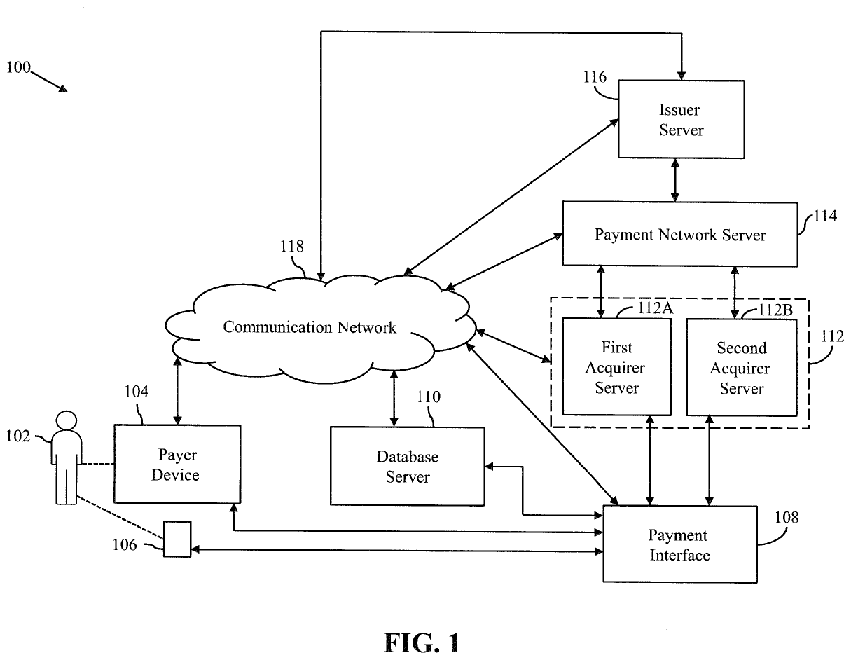

FIG. 1 is a block diagram that illustrates a communication environment 100 for processing transactions, in accordance with an embodiment of the present invention. The communication environment 100 includes a payer 102 in possession of a payer device 104 and a transaction card 106. The communication environment 100 further includes a payment interface 108, a database server 110, first and second acquirer servers 112A and 112B (hereinafter referred to as “acquirer servers 112”), a payment network server 114, and an issuer server 116. The payer device 104, the payment interface 108, the database server 110, the acquirer servers 112, the payment network server 114, and the issuer server 116 communicate with each other by way of a communication network 118 or through separate communication networks established therebetween.

The payer 102 is an individual, who is an account holder of a payer account. In one embodiment, the payer account is an account maintained by a financial institution, such as an issuer. The transaction card 106 that stores information of the payer account (hereinafter referred to as “account information”) is linked to the payer account. The account information may be stored in an electronic chip or a machine readable magnetic strip embedded in the transaction card 106. The account information may include an account number, a name of an account holder (i.e., the payer 102), or the like. The transaction card 106 has a unique card number, an expiry date, a card security code, and a card type associated to it. The card number, the expiry date, the card security code, and the card type constitute transaction card details of the transaction card 106. In one embodiment, the transaction card 106 is a physical card. In another embodiment, the transaction card 106 is a virtual card that is stored electronically in a memory (not shown) of the payer device 104. Examples of the transaction card 106 include a credit card, a debit card, a charge card, a prepaid card, or the like. In one scenario, the payer 102 may use the transaction card 106 as a payment mode for performing transactions for various purchases that she wants to make. In another scenario, the payer 102 may use the payer account as a payment mode for performing the transactions. In another embodiment, the payer account is a digital wallet maintained by a third-party service provider. The payer 102 may use the digital wallet as a payment mode for performing the transactions.

The payer device 104 is a communication device of the payer 102. In one embodiment, the payer 102 uses the payer device 104 to initiate transactions that correspond to the purchases made by the payer 102. Examples of the payer device 104 include, but are not limited to, a mobile phone, a smartphone, a laptop, a tablet, a phablet, or any other communication device.

The payment interface 108 is an interface that enables the payer 102 to perform the transactions for the purchases that the payer 102 has made. In one embodiment, the payment interface 108 is a Point-of-Sale (POS) device, a Point-of-Interest (POI) device, a Point-of-Purchase (POP) device, and the like. In another embodiment, the payment interface 108 is an application server that hosts an application interface, such as a payment gateway, a net-banking application, or the like. The payment interface 108 receives transaction details of a transaction initiated by the payer 102 for a purchase made by her. The transaction details include a payer identifier corresponding to the payer 102, the account information of the payer 102, a first payee identifier of a first payee, a payment amount for the purchase, and the like. The payer identifier may be a name, a contact number, a taxpayer identification number (TIN) of the payer 102, or any other identification information that uniquely identifies the payer 102. The first payee may be a direct beneficiary of the purchase, for example, when the payer 102 makes the purchase from the first payee. The first payee identifier includes account information of a first payee account of the first payee, a TIN of the first payee, a merchant category code (MCC), a nature of purchase, a type of service provided by the first payee, and the like. In an embodiment, the first payee identifier can be a numeric code. In another embodiment, the first payee identifier can be a Quick Response (QR) code.

Based on the transaction details, the payment interface 108 generates an authorization request to be communicated to the issuer of the payer 102 for authorizing the transaction. When the transaction is authorized, the payment interface 108 accesses a first database to retrieve a proportion value that corresponds to the first payee identifier. The proportion value indicates a proportion of the payment amount that is to be withheld for a second payee. The second payee may be an indirect beneficiary of the purchase made by the payer 102. Examples of the second payee include a government agency, a third-party tax collection agency, or any other entity entitled to derive indirect benefit from the purchase. The proportion value may be expressed as a ratio, a percentage, a fixed amount that is independent of the payment amount, or the like. Based on the retrieval of the proportion value, the payment interface 108 determines a withhold amount that corresponds to the proportion value and initiates a withholding of the withhold amount from the payer account. In one embodiment, the purchase amount may be inclusive of the withhold amount, such that the withhold amount corresponds to a part of the payment amount. In another embodiment, the purchase amount may be exclusive of the withhold amount. In one scenario, the payment interface 108 initiates a deposit of a remaining part of the payment amount in the first payee account, when the payment amount is inclusive of the withhold amount. The remaining part of the payment amount is an amount that remains after the withhold amount is withheld from the payment amount. In an alternate scenario, the payment interface 108 initiates a deposit of the payment amount in the first payee account, when the payment amount is exclusive of the withhold amount. The payment interface 108 further accesses one of the first database or a second database to retrieve account information of a second payee account of the second payee by using the first payee identifier. The payment interface 108 further initiates a deposit of the withhold amount in the second payee account against the TIN of the first payee. When the withhold amount is deposited, the payment interface 108 communicates a certificate (such as a tax certificate, a receipt of payment, or the like) to the payer 102, the first payee, and the second payee. The certificate indicates that the withhold amount corresponding to the purchase made by the payer 102 is successfully deposited in the second payee account against the TIN of the first payee.

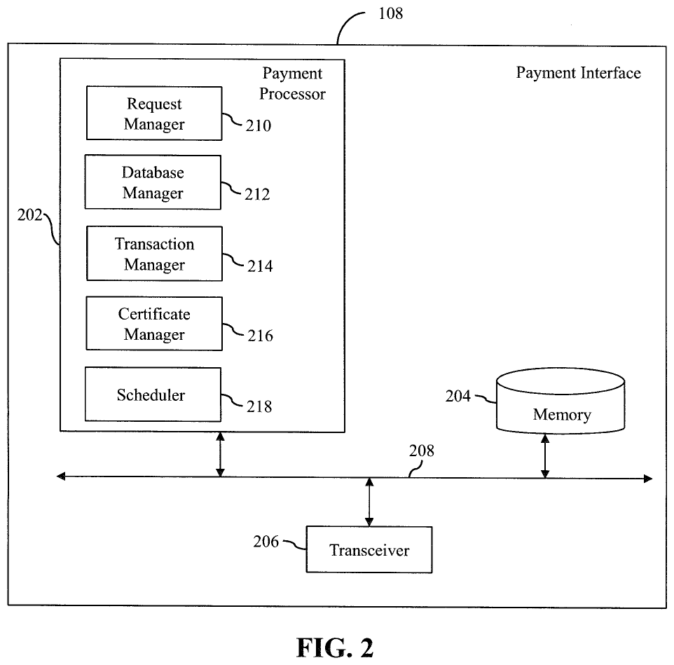

The payment interface 108 is implemented by one of a merchant server (not shown), the payment network server 114, the issuer server 116, or any other entity that processes transactions for purchases, such as a payment interface server (not shown). Functional components of the payment interface 108 are explained later in conjunction with FIG. 2.

The database server 110 is a data management and storage server that manages and stores the first and second databases, such as look-up tables, third-party ledgers, or the like. The first and second databases are frequently updated based on any update in the data included in the first and second databases. The database server 110 performs various database operations, such as receiving, storing, processing, and transmitting queries, data, or content. For querying the database server 110, various querying languages, such as SQL®, QUEL®, and DMX®, may be utilized. For example, the payment interface 108 may query the database server 110 by using one such querying language for accessing the first and second databases. The database server 110 is realized through various technologies, such as Microsoft® SQL Server, Oracle®, IBM DB2®, Microsoft Access®, PostgreSQL®, MySQL®, SQLite®, or the like. In this embodiment, the database server 110 is represented as a stand-alone entity, however in other embodiments, the database server 110 may be a part of the payment interface 108, without deviating from the scope of the invention.

The first acquirer server 112A is a computing server that is associated with a financial institution, such as a first acquirer. The first payee has established the first payee account with the first acquirer to accept payments for products and/or services. The first acquirer processes various transactions by using the first acquirer server 112A. For example, the first acquirer server 112A credits one of the remaining part of the payment amount or the purchase amount to the first payee account, when the transaction for the purchase made by the payer 102 is processed.

The second acquirer server 112B is a computing server that is associated with another financial institution, such as a second acquirer. The second payee has established the second payee account with the second acquirer to accept withhold amounts corresponding to various purchases made from the first payee. For example, the second acquirer server 112B credits the second payee account with the withhold amount corresponding to the purchase made by the payer 102 from the first payee.

The payment network server 114 is a computing server of a payment network of transaction cards, such as the transaction card 106. The payment network server 114 receives authorization requests from the payment interface 108 or the first acquirer server 112A and transmits the authorization requests to the issuer server 116 for performing authorization of transactions.

The issuer server 116 is a computing server that is associated with the issuer. The issuer is yet another financial institution that manages payer accounts of multiple payers. Account details of the payer accounts (such as the payer account of the payer 102) established with the issuer are stored as account profiles in a memory (not shown) of the issuer server 116 or on a cloud server associated with the issuer server 116. The account details may include an account balance, a credit line, details of an account holder, transaction history of the account holder, account information, transaction card details, or the like. The details of the account holder may include name, age, gender, physical attributes, registered contact number, alternate contact number, registered e-mail ID, or the like. The issuer server 116 authorizes various transactions based on the corresponding authorization requests. Methods for processing the transactions via the acquirer server 112, the payment network server 114, and the issuer server 116 will be apparent to persons having skill in the art and may include processing the transactions via the traditional four-party system or the traditional three-party system.

Examples of the acquirer servers 112, the payment network server 114, and the issuer server 116 include, but are not limited to, computers, laptops, mini-computers, mainframe computers, any non-transient and tangible machines that can execute a machine-readable code, cloud-based servers, distributed server networks, or a network of computer systems.

The communication network 118 is a medium through which content and messages are transmitted between various entities, such as the payer device 104, the payment interface 108, the database server 110, the acquirer servers 112, the payment network server 114, and the issuer server 116. Examples of the communication network 118 include, but are not limited to, a near-field communication (NFC) based network, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the communication environment 100 may connect to the communication network 118 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof.

FIG. 2 is a block diagram that illustrates the payment interface 108, in accordance with an embodiment of the present invention. The payment interface 108 includes a payment processor 202, a memory 204, and a transceiver 206. The payment processor 202, the memory 204, and the transceiver 206 communicate with each other by way of a communication bus 208.

The payment processor 202 includes suitable logic, circuitry, and/or interfaces to execute instructions stored in the memory 204 for performing various transaction processing operations. The payment processor 202 receives transaction details of a transaction, when the payer 102 performs the transaction using the payer device 104, the transaction card 106, the payer account, the digital wallet, or any other payment mode. When the transaction is authorized, the payment processor 202 uses the first payee identifier included in the transaction details as a pointer to access the first database for retrieving a relevant proportion value. The payment processor 202 initiates withholding of the withhold amount that corresponds to the retrieved proportion value and initiates the deposit of one of the remaining part of the payment amount or the payment amount in the first payee account. The payment processor 202 further accesses one of the first or second database to retrieve account details of the second payee account and initiates the deposit of the withhold amount in the second payee account. The payment processor 202 further communicates a certificate to the payer 102, the first payee, and the second payee that indicate successful deposit of the withhold amount in the second payee account. The payment processor 202 performs the transaction processing operations by way of a request manager 210, a database manager 212, a transaction manager 214, a certificate manager 216, and a scheduler 218. Examples of the payment processor 202 include, but are not limited to, an application specific integrated circuit (ASIC) processor, a reduced instruction set computer (RISC) processor, a complex instruction set computer (CISC) processor, or a field programmable gate array (FPGA). It will be apparent to a person skilled in the art that the payment processor 202 is compatible with multiple operating systems.

The request manager 210 initiates authorization requests for transactions performed by the payer 102 at the payment interface 108. A transaction is authorized, when verification of account information or transaction card details of the payer 102 corresponding to the transaction is successful.

The database manager 212 queries the database server 110 to access the first database for retrieving the proportional value. The database manager 212 further queries the database server 110 to access one of the first or second database for retrieving the account details of the second payee account for the deposit of the withhold amount.

The transaction manager 214 performs various transaction processing operations. In one embodiment, the transaction manager 214 processes the transaction in real-time or near real-time. In another embodiment, the transaction manager 214 processes the transaction as a batch. The batch processing of transactions is known to those of ordinary skill in the art.

The certificate manager 216 performs various operations associated with certificate management. In one embodiment, the certificate manager 216 receives a certificate from the second acquirer server 112B or the issuer server 116 based on the successful deposit of the withhold amount in the second payee account. In another embodiment, the certificate manager 216 generates the certificate based on a notification from the second acquirer server 112B indicating the successful deposit of the withhold amount in the second payee account. The certificate manager 216 communicates the certificate to the payer 102, the first payee, and the second payee by way of a short message service (SMS) or an electronic mail (e-mail). In another embodiment, the certificate manager 216 may post the certificate on an application program interface (API) of an enterprise resource planning (ERP) system (not shown). The payer 102 and the first and second payees may retrieve the certificate by accessing the API.

The scheduler 218 generates a schedule for processing various transactions as a batch. The schedule includes a date and time for the processing of the transactions. The scheduler 218 further communicates the schedule to the concerned entities, such as the payer 102, the first payee, and the second payees.

The memory 204 includes suitable logic, circuitry, and/or interfaces to store the instructions that are executed by the payment processor 202 for performing the transaction processing operations. The memory 204 stores transaction details of various transactions as a transaction log. In one embodiment, the memory 204 may temporarily store the proportion value retrieved from the database server 110. Examples of the memory 204 include, but are not limited to, a random-access memory (RAM), a read-only memory (ROM), a programmable ROM (PROM), and an erasable PROM (EPROM).

The transceiver 206 includes suitable logic, circuitry, and/or interfaces to transmit (or receive) data to (or from) the database server 110, the acquirer servers 112, the payment network server 114, or other entities that are pursuant to one or more standards for the interchange of transaction messages, such as the ISO8583 standard. For example, the transceiver 206 transmits the authorization requests to the acquirer servers 112 and queries to the database server 110 for accessing the first and second databases. The transceiver 206 further communicates the certificate to the payer 102, the first payee, and the second payee. Examples of the transceiver 206 include, but are not limited to, an antenna, a radio frequency transceiver, a wireless transceiver, a Bluetooth transceiver, an ethernet port, a universal serial bus (USB) port, or any other device configured to transmit and receive data. The transceiver 206 communicates with the communication network 118 using various wired and wireless communication protocols, such as TCP/IP, UDP, 2G, 3G, 4G, 5G communication protocols, LTE communication protocols, or any combination thereof.

Though, the payment processor 202 is depicted as a hardware component in FIG. 2, a person skilled in the art will appreciate that the scope of the invention is not limited to realizing the payment processor 202 as the hardware component. In another embodiment, the functionality of the payment processor 202 may be implemented by way of a computer executable code or a set of computer readable instructions stored in the memory 204, without deviating from the spirit of the invention.

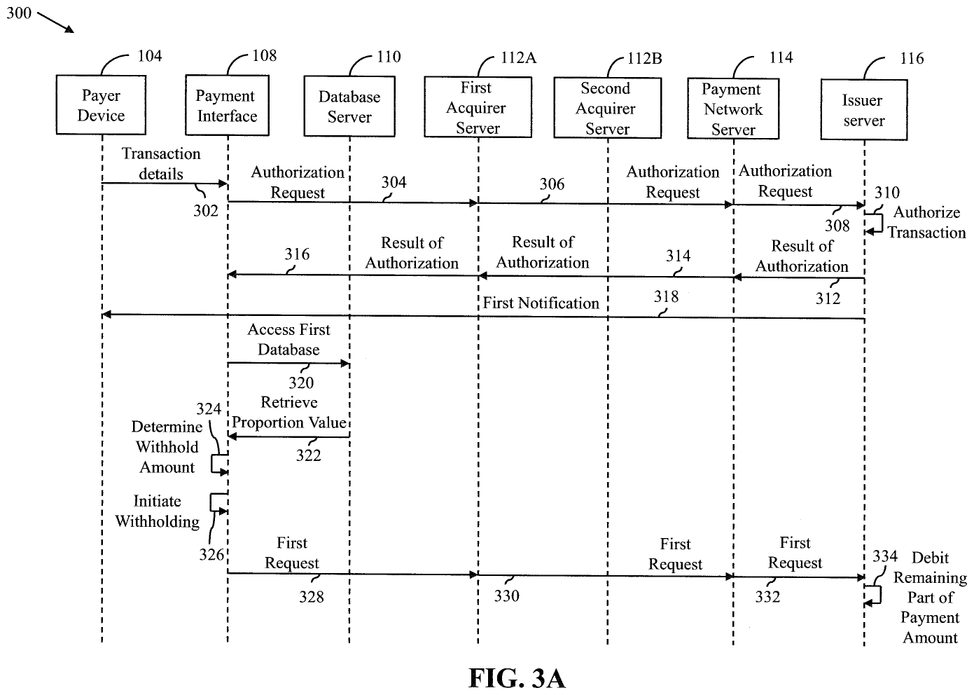

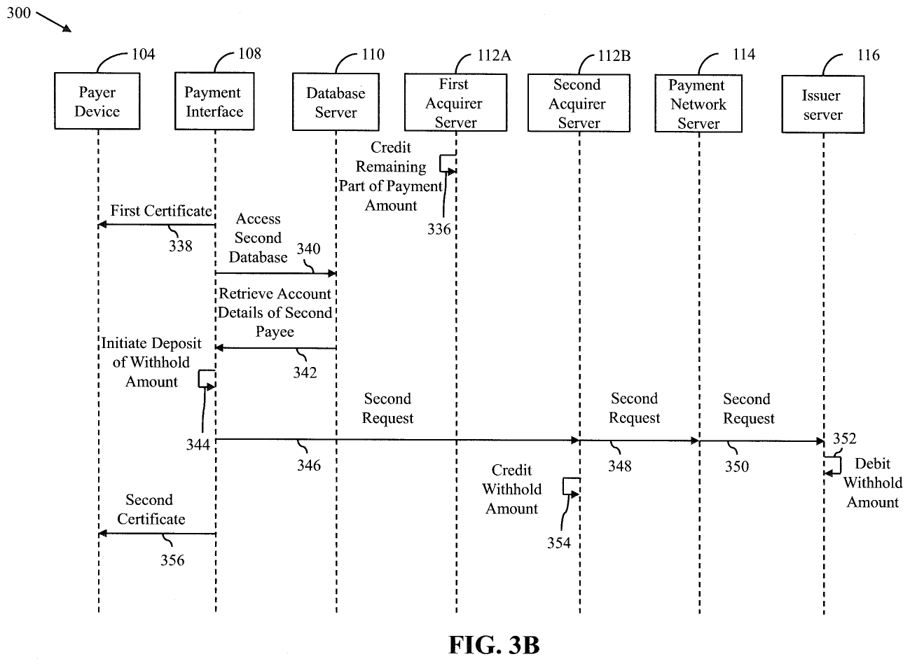

FIGS. 3A and 3B, collectively represent a process flow diagram 300 to illustrate an exemplary scenario for processing transactions that are inclusive of tax by using the payment interface 108, in accordance with an embodiment of the present invention. The process flow diagram 300 illustrates the scenario where the payer 102 performs a transaction at the payment interface 108 for a purchase. It will be apparent to a person having ordinary skill in the art that the payer 102 can use the payer device 104, the transaction card 106, the digital wallet, the payer account, or any other payment mode to perform the transaction at the payment interface 108. In one embodiment, the purchase may be a business to business (B2B) purchase, such that the payer 102 is a merchant who has made the purchase from a vendor. In another embodiment, the purchase may be a business to consumer (B2C) purchase, such that the payer 102 is a customer who has made the purchase from a merchant. The process flow diagram 300 involves the payer device 104, the payment interface 108, the database server 110, the first acquirer server 112A, the second acquirer server 112B, the payment network server 114, and the issuer server 116.

Transaction details of a transaction are received by the payment interface 108 from the payer device 104, when the payer 102 performs the transaction (as shown by arrow 302). For example, the payer 102 performs the transaction for a payment amount of $500 to pay for the goods that she has purchased from a vendor (i.e., the first payee). In this scenario, the first payee is the direct beneficiary of the purchase and the payment amount of $500 is inclusive of tax.

Based on the transaction details, the request manager 210 initiates an authorization request. The request manager 210, in conjunction with the transceiver 206, transmits the authorization request to the issuer server 116 by way of the first acquirer server 112A and the payment network server 114 (as shown by arrows 304, 306, and 308, respectively). Based on the authorization request, the issuer server 116 authorizes the transaction (as shown by arrow 310). For authorizing the transaction, the issuer server 116 determines whether an available credit line or an account balance of the payer account from which the payer 102 has performed the transaction is sufficient to cover the payment amount. In one scenario, the issuer server 116 may decline the transaction, when the authorization is unsuccessful. In an alternate scenario, when the authorization is successful, the issuer server 116 may approve the transaction. The issuer server 116 may further authenticate the payer 102, prior to the authorization of the transaction, by using one or more authentication techniques that are known in the art. The issuer server 116 communicates a result of authorization to the payment interface 108 by way of the payment network server 114 and the first acquirer server 112A (as shown by arrows 312, 314, and 316, respectively). The issuer server 116 further notifies the payer 102 by way of a first notification that the transaction is successfully authorized (as shown by arrow 318).

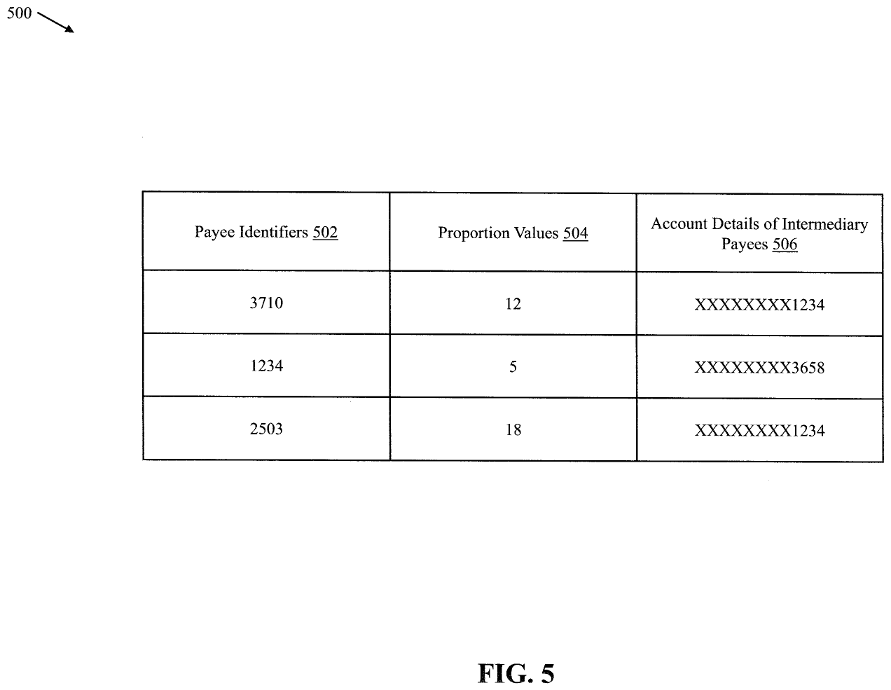

When the result of authorization indicates that the transaction is successfully authorized, the database manager 212 retrieves the first payee identifier included in the transaction details. The first payee identifier is a QR code that includes the MCC of the first payee, a nature of payment (such as a rent, a restaurant bill, an electricity bill, an educational fee, a purchase order payment, or the like) for the purchase, a nature of business (such as a retail store, a restaurant, an educational institute, or the like) of the first payee, the TIN of the first payee, and the like. The database manager 212 uses the first payee identifier as a pointer to access the first database (such as a look-up table or a third-party ledger) stored in the database server 110 (as shown by arrow 320). The first database includes proportion values corresponding to payee identifiers of various payees including the first payee. An exemplary first database is described later in conjunction with FIG. 5.

The database manager 212 retrieves a proportional value (for example, 12%) from a field of the first database that is pointed by the first payee identifier (as shown by arrow 322). Based on the proportional value (i.e., 12%), the transaction manager 214 determines a withhold amount that needs to be reserved for a second payee, who is an indirect beneficiary of the purchase (as shown by arrow 324). For example, the second payee is the tax collection authority and the withhold amount is the tax that the second payee is subject to receiving for the purchase. In this scenario, when the payment amount is $500, the withhold amount amounts to 12% of $500 (i.e., $60).

Based on the determined withhold amount, the transaction manager 214 initiates withholding of the withhold amount (as shown by arrow 326). For withholding the withhold amount from the payment amount, the transaction manager 214 communicates a first request to the issuer server 116 by way of the first acquirer server 112A and the payment network server 114 (as shown by arrows 328, 330, and 332, respectively). The first request includes details of the payer account, the withhold amount, and the first payee account in which remaining part of the payment amount is to be credited. The remaining part of the payment amount corresponds to a difference of the purchase amount and the withhold amount. The issuer server 116 receives the first request. Based on the first request, the issuer server 116 debits the remaining part of the payment amount from the payer account and withholds (i.e., reserving) the withhold amount from the payer account (as shown by arrow 334). Thus, $440 is debited and $60 is withheld for the second payee from the payer account. The first acquirer server 112A then credits the remaining part of the payment amount to the first payee account (as shown by arrow 336). It will be apparent to a person having ordinary skill in the art that information flow between the issuer server 116 and the first acquirer server 112A is through the payment network server 114 and is known to those of skill in the art. Once the remaining part of the payment amount is credited to the first payee account, the certificate manager 216 communicates a first certificate to the payer device 104 (as shown by arrow 338). The first certificate indicates that the first payee has received the remaining part of the payment amount.

The database manager 212 further uses the first payee identifier as a pointer to access the second database stored in the database server 110 (as shown by arrow 340). The second database includes account details of all intermediary payees that correspond to various payee identifiers and are subject to receiving withhold amounts. For example, the second database may include account details of the tax collection authority (i.e., the second payee) that is subject to receiving taxes (i.e., the withhold amounts) associated with any purchase made from the first payee. The account details of all intermediary payees may be stored in an encrypted format. The database manager 212 retrieves the account details of the second payee account from a field of the second database that is pointed by the first payee identifier (as shown by arrow 342). In another embodiment, the account details of all the intermediary payees may be included in the first database itself. In such a scenario, the database manager 212 uses the first payee identifier to access the first database for retrieving the account details of the second payee account. In another embodiment, when the first database includes both the proportional values and the account details of all the intermediary payees, the database manager 212 may access the first database once to retrieve both the proportional value and the account details of the second payee account.

Once the account details of the second payee account are retrieved, the transaction manager 214 initiates deposit of the withhold amount in the second payee account (as shown by arrow 344). For initiating the deposit of the withhold amount, the transaction manager 214, in conjunction with the transceiver 206, transmits a second request to the issuer server 116 by way of the second acquirer server 112B (i.e., associated with the second acquirer maintaining the second payee account) and the payment network server 114 (as shown by arrows 346, 348, and 350, respectively). The second request includes the details of the payer account, the withhold amount, and the second payee account in which the withhold amount is to be credited. The issuer server 116 receives the second request and debits the withhold amount from the payer account (as shown by arrow 352). In this scenario, $60 is debited from the payer account. The second acquirer server 112B then credits the withhold amount to the second payee account against the TIN of the first payee (as shown by arrow 354). Once the withhold amount is credited to the second payee account, the certificate manager 216 communicates a second certificate to the payer device 104 (as shown by arrow 356). The certificate manager 216 may further communicate the second certificate to the first payee and the second payee to indicate that the second payee has successfully received the withhold amount. In one embodiment, the first and second certificates may be generated by the first and second acquirer servers 112A and 112B, respectively, or the issuer server 116 and communicated to the payment interface 108. In another embodiment, the first and second certificates may be generated by the payment interface 108. The first and second certificates are communicated by way of SMSs, e-mails, or the API of the ERP system. The payer 102 and the first and second payees may retrieve the first and second certificates by accessing the API.

In another embodiment, when the deposit of the withhold amount is not real time or near real time, the scheduler 218 generates a schedule for the deposit of the withhold amount in the second payee account. The schedule indicates a date and time for the deposit of the withhold amount in the second payee account. The scheduler 218, in conjunction with the transceiver 206, communicates the schedule to the first payee and the second payee. In yet another embodiment, the transaction manager 214 may initiate deposit of the withhold amounts corresponding to multiple purchases in a batch, without deviating from the scope of the invention.

For the sake of simplicity, the abovementioned exemplary scenario illustrates the splitting of the purchase amount between the first and second payees. In another scenario, where there are multiple indirect beneficiaries associated with a purchase and the payment amount is inclusive of withhold amounts, the purchase amount may be split among more than two payees based on their corresponding proportional values retrieved from the first database, without deviating from the scope of the invention. For example, the payer 102 may perform a transaction to pay a purchase amount (i.e., inclusive of tax) for a restaurant bill and includes a tip amount along with the purchase amount. In such a scenario, the payment interface 108 splits a total amount among the restaurant owner, the tax collection authority, and a restaurant attendant, who is subject to receiving the tip, based on their corresponding shares. Share of the tax collection authority and the tip amount for the restaurant attendant correspond to withhold amounts in this example.

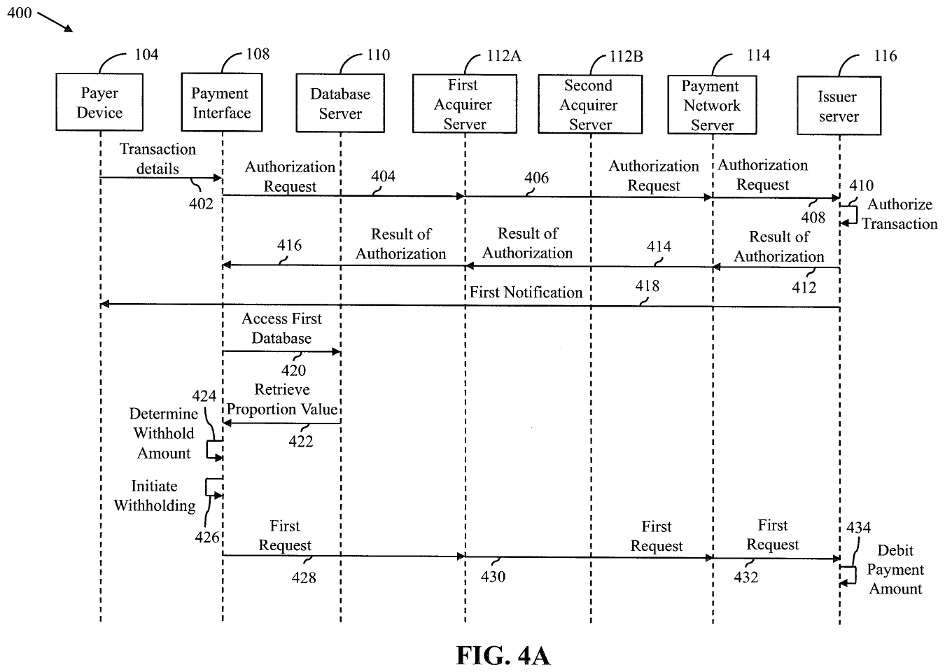

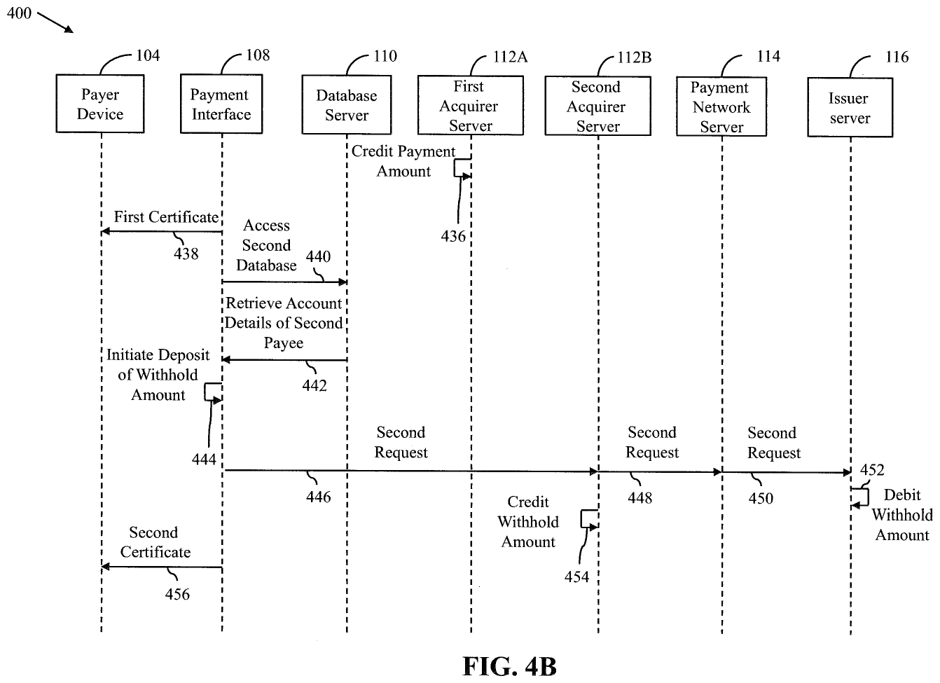

FIGS. 4A and 4B, collectively represent a process flow diagram 400 to illustrate an exemplary scenario for processing transactions that are exclusive of tax by using the payment interface 108, in accordance with an embodiment of the present invention. The process flow diagram 400 illustrates the scenario where the payer 102 performs a transaction at the payment interface 108 for a purchase. In one embodiment, the purchase may be a B2B purchase, such that the payer 102 is a merchant who has made the purchase from a vendor. In another embodiment, the purchase may be a B2C purchase, such that the payer 102 is a customer who has made the purchase from a merchant. The process flow diagram 400 illustrates the payer device 104, the payment interface 108, the database server 110, the first acquirer server 112A, the second acquirer server 112B, the payment network server 114, and the issuer server 116.

Transaction details for the transaction are received by the payment interface 108 from the payer device 104, when the payer 102 performs the transaction (as shown by arrow 402). For example, the payer 102 performs the transaction for a payment amount of $500 to pay for the goods that she has purchased from a vendor (i.e., the first payee). In this scenario, the first payee is the direct beneficiary of the purchase and the payment amount of $500 is exclusive of any tax associated with the purchase.

Based on the transaction details, the request manager 210 initiates an authorization request. The authorization request is transmitted to the issuer server 116 by way of the first acquirer server 112A and the payment network server 114 (as shown by arrows 404, 406, and 408, respectively). Based on the authorization request, the issuer server 116 authorizes the transaction (as shown by arrow 410). The issuer server 116 communicates a result of authorization to the payment interface 108 by way of the payment network server 114 and the first acquirer server 112A (as shown by arrows 412, 414, and 416, respectively). The issuer server 116 further notifies the payer 102 by way of the first notification to indicate that the transaction is successfully authorized (as shown by arrow 418).

When the result of authorization indicates that the transaction is successfully authorized, the database manager 212 retrieves the first payee identifier from the transaction details. The database manager 212 uses the first payee identifier as a pointer to access the first database (such as a look-up table or a third-party ledger) stored in the database server 110 (as shown by arrow 420).

The database manager 212 retrieves a proportional value (for example, 6%) from a field of the first database that is pointed by the first payee identifier (as shown by arrow 422). Based on the proportional value (i.e., 6%), the transaction manager 214 determines a withhold amount that needs to be reserved for a second payee, who is an indirect beneficiary of the purchase (as shown by arrow 424). For example, the second payee is the tax collection authority and the withhold amount is the tax that the second payee is subject to receiving for the purchase. In this scenario, when the payment amount is $500, the withhold amount amounts to 6% of $500 (i.e., $30).

The transaction manager 214 initiates withholding of the withhold amount (as shown by arrow 426) from the payer account. For withholding the withhold amount, the transaction manager 214 transmits the first request to the issuer server 116 by way of the first acquirer server 112A and the payment network server 114 (as shown by arrows 428, 430, and 432, respectively). The first request includes details of the payer account, the withhold amount, and the first payee account in which the payment amount is to be credited. The issuer server 116 receives the first request. Based on the first request, the issuer server 116 debits the payment amount and withholds the withhold amount, from the payer account (as shown by arrow 434). Thus, $500 is debited and $30 is withheld for the second payee from the payer account. The first acquirer server 112A then credits the payment amount to the first payee account (as shown by arrow 436). It will be apparent to a person having ordinary skill in the art that information flow between the issuer server 116 and the first acquirer server 112A is through the payment network server 114. Once the payment amount is credited to the first payee account, the certificate manager 216 communicates the first certificate to the payer device 104 (as shown by arrow 438). The first certificate indicates that the first payee has received the payment amount.

The database manager 212 further uses the first payee identifier as a pointer to access the second database stored in the database server 110 (as shown by arrow 440). The database manager 212 retrieves the account details of the second payee account from a field of the second database that is pointed by the first payee identifier (as shown by arrow 442). In another embodiment, when the account details of all the intermediary payees are included in the first database itself, the database manager 212 uses the first payee identifier to access the first database for retrieving the account details of the second payee account.

Once the account details of the second payee account are retrieved, the transaction manager 214 initiates deposit of the withhold amount in the second payee account (as shown by arrow 444). For initiating the deposit of the withhold amount, the transaction manager 214, in conjunction with the transceiver 206, transmits the second request to the issuer server 116 by way of the second acquirer server 112B and the payment network server 114 (as shown by arrows 446, 448, and 450, respectively). The second request includes the details of the payer account, the withhold amount, and the second payee account in which the withhold amount is to be credited. The issuer server 116 receives the second request and debits the withhold amount from the payer account (as shown by arrow 452). In this scenario, $30 is debited from the payer account. The second acquirer server 112B then credits the withhold amount to the second payee account against the TIN of the first payee (as shown by arrow 454). Once the withhold amount is credited to the second payee account, the certificate manager 216 communicates the second certificate to the payer device 104 (as shown by arrow 456). The certificate manager 216 may further communicate the second certificate to the first payee and the second payee to indicate that the second payee has successfully received the withhold amount.

In another embodiment, the deposit of the withhold amount may be based on the schedule generated by the scheduler 218. In yet another embodiment, the transaction manager 214 may initiate deposit of the withhold amounts corresponding to multiple purchases in a batch, without deviating from the scope of the invention.

For the sake of simplicity, the abovementioned exemplary scenario illustrates the deposit of the withhold amount in a single account (i.e., the second payee account). In another scenario, where there are multiple indirect beneficiaries associated with a purchase, the transaction manager 214 initiates deposit of withhold amounts in accounts of more than one payee based on their corresponding proportional values retrieved from the first database, without deviating from the scope of the invention.

FIG. 5 is a block diagram that illustrates an exemplary look-up table 500 (i.e., the first database) stored in the database server 110, in accordance with an embodiment of the present invention. The look-up table 500 includes various sections such as a first section 502, a second section 504, and a third section 506.

The first section 502 includes payee identifiers (for example, MCCs or TINs) of various payees, such as various vendors. An MCC is a classification code that is assigned by a payment network to a vendor (such as the first payee) based on the predominant business activity of the vendor. A TIN is an identification code that is issued by the tax collection authority to a vendor (such as the first payee) for tax purposes. The second section 504 includes various proportion values corresponding to the payee identifiers. A proportion value indicates a proportion of a payment amount that is to be paid as withhold amount to an intermediary payee, such as the tax collection authority. The proportion values depend on the payee identifiers. In this example, the proportion values are expressed as percentages. The third section 506 includes account details of various intermediary payees (such as tax collection authorities or any other authority) that are subject to receiving withhold amounts corresponding to the payee identifiers in the first section 502.

In one embodiment, the database manager 212 accesses the look-up table 500 by using the first payee identifier (for example, 3710) of the first payee as a pointer. In this example, the first payee identifier is a vendor identifier of a vendor (i.e., the first payee). The vendor identifier points to a first field (i.e., a first row) of the look-up table 500. The database manager 212 retrieves a proportion value (i.e., 12%) and account details of an intermediary payee (i.e., 1234) that are included in the field pointed by the vendor identifier. In this example, the intermediary payee is the tax collection authority. The retrieved proportion value (i.e., 12%) and account details of the tax collection authority (i.e., 1234) are used by the transaction manager 214 for determining and withholding the withhold amount for the tax collection authority as explained in the foregoing in FIGS. 3A and 3B, and 4A and 4B.

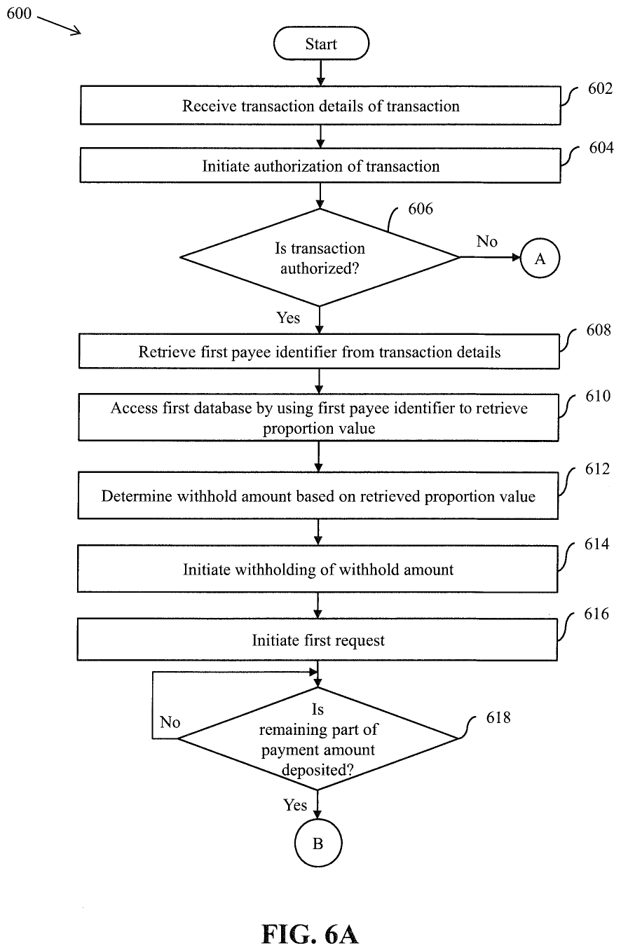

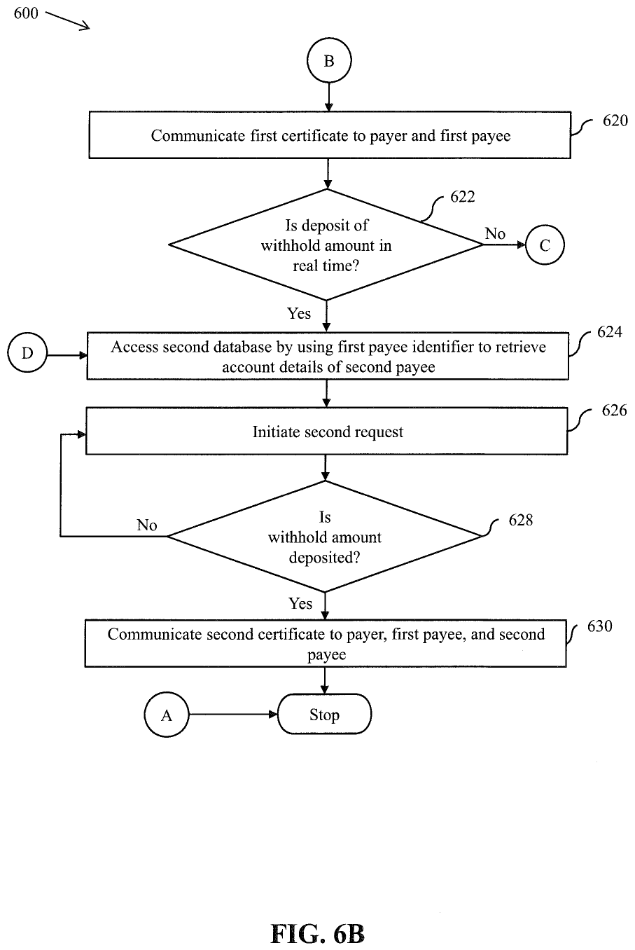

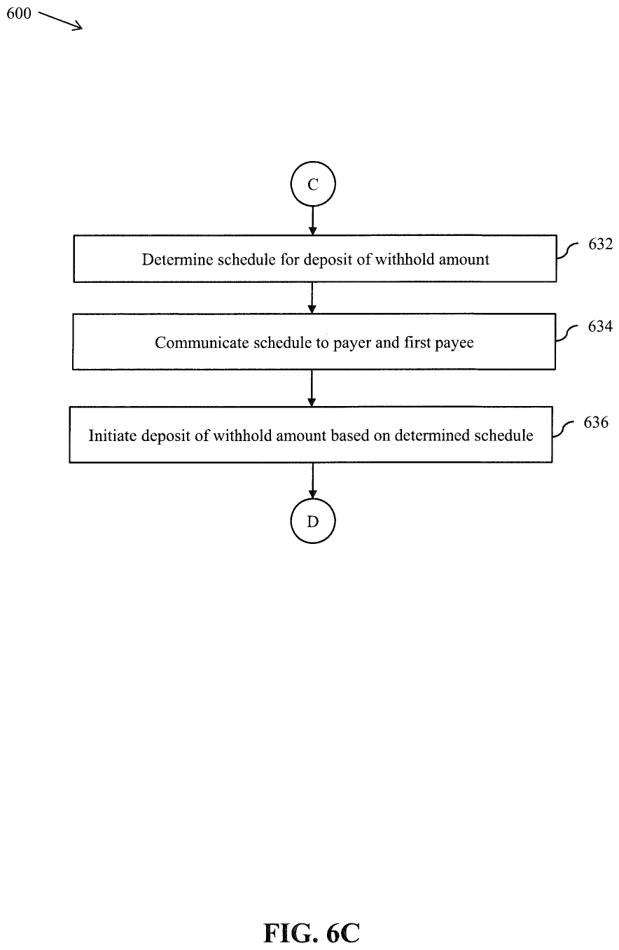

FIGS. 6A, 6B, and 6C, collectively represent a flow chart 600 that illustrates a method for processing transactions, in accordance with an embodiment of the present invention. The flow chart 600 is explained in conjunction with FIGS. 1, 2, 3A and 3B, 4A and 4B, and 5. In one embodiment, the payment interface 108 may be a standalone entity managed by a third-party server (not shown) to process transactions. In another embodiment, the payment interface 108 may be implemented by one of the merchant server, the payment network server 114, or the issuer server 116 to process transactions. In one example, the issuer server 116 may implement the payment interface 108 as a net-banking server to host a net-banking application on the payer device 104 for processing transactions. In another example, when the payer 102 is a merchant, the payment interface 108 may refer to a merchant server of the merchant that enables the merchant to make payments to various vendors. In yet another example, the payment network server 114 may implement the payment interface 108 as a payment processing server that enables multiple payees that derive benefit from the transaction to get their share.

The payer 102 performs a transaction by way of the payer device 104, the transaction card 106, the payer account, the digital wallet, or any other payment mode. At step 602, the payment interface 108 receives transaction details of the transaction performed by the payer 102. The transaction details include the payer identifier of the payer 102, the account information of the payer 102, the first payee identifier of the first payee, and a payment amount for the purchase. The first payee identifier includes the account details of the first payee account of the first payee, the TIN of the first payee, a nature of purchase, and the like. At step 604, the payment interface 108 initiates authorization for the transaction as explained in foregoing in FIGS. 3A and 3B. At step 606, the payment interface 108 checks whether the transaction is authorized. If at step 606, it is determined that the transaction is not authorized, the payment interface 108 terminates the processing of the transaction. If at step 606, it is determined that the transaction is authorized, step 608 is performed. At step 608, the payment interface 108 retrieves the first payee identifier from the transaction details. In one example, the first payee identifier is a QR code.

At step 610, the payment interface 108 accesses the first database stored in the database server 110 by using the first payee identifier to retrieve a proportion value that corresponds to the first payee identifier. At step 612, the payment interface 108 determines a withhold amount based on the retrieved proportion value. The withhold amount represents the first part of the payment amount that is derived based on the retrieved proportion value as explained in FIGS. 3A and 3B. At step 614, the payment interface 108 initiates withholding of the withhold amount. At step 616, the payment interface 108 initiates the first request. Based on the first request, the issuer server 116 debits the remaining part of the payment amount from the first payee account and reserves the withhold amount.

At step 618, the payment interface 108 checks whether the remaining part of the payment amount is deposited in the first payee account. If at step 618, it is determined that the remaining part of the payment amount is not deposited in the first payee account, the payment interface 108 waits until the remaining part of the payment amount gets deposited in the first payee account. If at step 618, it is determined that the remaining part of the payment amount is deposited in the first payee account, step 620 is performed.

At step 620, the payment interface 108 communicates the first certificate to the payer device 104 and the first payee to indicate that the remaining part of the payment amount is successfully deposited in the first payee account. At step 622, the payment interface 108 checks whether the deposit of the withhold amount is to be initiated in real time or near real time. If at step 622, it is determined that the deposit of the withhold amount is to be initiated in real time or near real time, step 624 is performed. At step 624, the payment interface 108 accesses the second database by using the first payee identifier to retrieve the account details of the second payee account of the second payee. In another embodiment, the payment interface 108 may access the first database to retrieve the account details of the second payee account of the second payee. At step 626, the payment interface 108 initiates the second request to deposit the withhold amount in the second payee account. Based on the second request, the issuer server 116 debits the withhold amount from the payer account. At step 628, the payment interface 108 checks whether the withhold amount is deposited in the second payee account. If at step 628, it is determined that the withhold amount is not deposited in the second payee account, the payment interface 108 waits until the withhold amount gets deposited in the second payee account. If at step 628, it is determined that the withhold amount is deposited in the second payee account, step 630 is performed. At step 630, the payment interface 108 communicates the second certificate to the payer device 104, the first payee, and the second payee to indicate that the withhold amount is successfully deposited in the second payee account.

If at step 622, it is determined that the deposit of the withhold amount is not to be initiated in real time or near real time, step 632 is performed. At step 632, the payment interface 108 determines a schedule for the deposit of the withhold amount in the second payee account. At step 634, the payment interface 108 communicates the determined schedule to the payer 102 and the first payee. The payment interface 108 may further communicate the determined schedule the second payee and any other concerned entity. At step 636, the payment interface 108 initiates the deposit of the withhold amount in the second payee account based on the determined schedule. For example, the payment interface 108 may initialize a timer to indicate whether the scheduled date and time included in the determined schedule has reached. Thus, the timer triggers the payment interface 108 to initiate the deposit of the withhold amount when the scheduled date and time is reached and the payment interface 108 performs step 624. In another embodiment, the payment interface 108 deposits the withhold amount as a batch.

It will be apparent to a person having ordinary skill in the art that when the purchase amount is exclusive of the withhold amount, the transaction manager 214 initiates deposit of the purchase amount in the first payee account instead of the remaining part of the purchase amount.

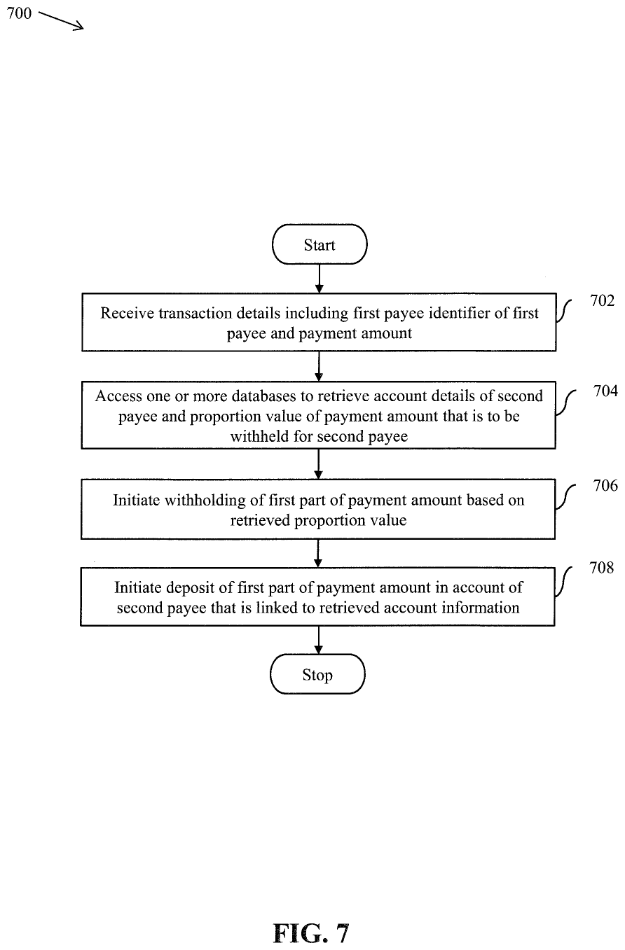

FIG. 7 represents a high-level flow chart 700 that illustrates a method for processing payments that are inclusive of tax, in accordance with an embodiment of the present invention. The flow chart 700 is explained in conjunction with FIGS. 1, 2, 3A and 3B, and 5.

The payer 102 performs a transaction by way of the payer device 104, the transaction card 106, the payer account, the digital wallet, or any other payment mode. At step 702, the payment interface 108 receives transaction details of the transaction. The transaction details include the first payee identifier of the first payee and a payment amount that corresponds to the transaction. At step 704, the payment interface 108 accesses one or more databases (such as the look-up table 500) by using the first payee identifier to retrieve the account details of the second payee and a proportion value of the payment amount that is to be withheld for the second payee. At step 706, the payment interface 108 initiates withholding of a first part of the payment amount (i.e., the withhold amount) based on the retrieved proportion value. At step 708, the payment interface 108 initiates deposit of the first part of the payment amount (i.e., the withhold amount) in the second payee account of the second payee, such that the second payee account is linked to the retrieved account details.

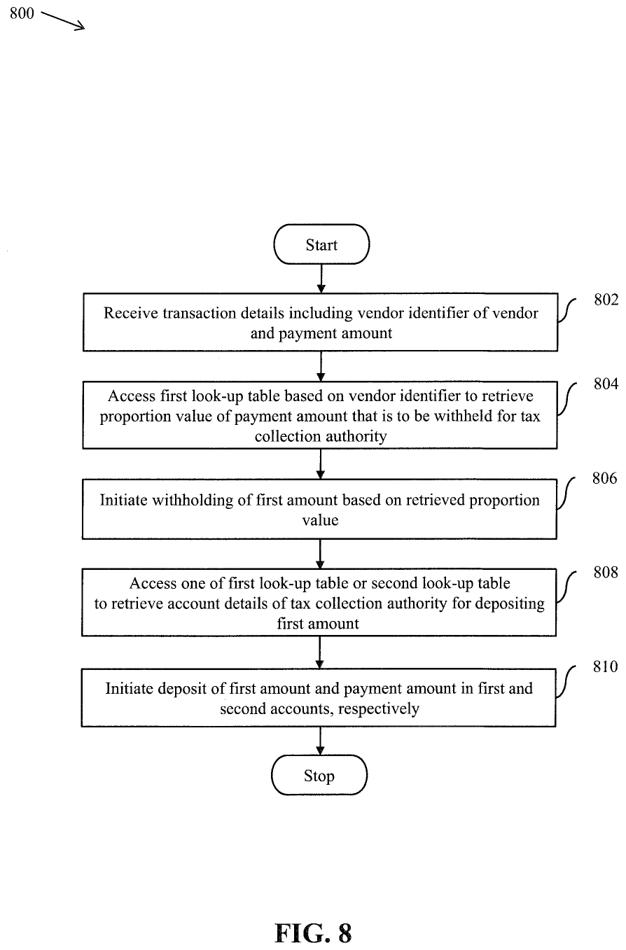

FIG. 8 represents a high-level flow chart 800 that illustrates a method for processing B2B payments that are exclusive of tax, in accordance with an embodiment of the present invention. The flow chart 800 is explained in conjunction with FIGS. 1, 2, 4A and 4B, and 5.

A merchant (such as the payer 102) makes a purchase of a purchase amount from a vendor and performs a transaction by way of the payer device 104, the transaction card 106, the payer account, the digital wallet, or any other payment mode for the purchase. At step 802, the payment interface 108 receives transaction details of the transaction. The transaction details include a vendor identifier of the vendor (i.e., the first payee) and the payment amount. At step 804, the payment interface 108 accesses a first look-up table (such as the look-up table 500) based on the vendor identifier to retrieve a proportion value of the payment amount that is to be withheld as tax for the tax collection authority. At step 806, the payment interface 108 initiates withholding of a first amount (i.e., the withhold amount) based on the retrieved proportion value. At step 808, the payment interface 108 accesses one of the first look-up table (such as the look-up table 500) or a second look-up table to retrieve account details of the tax collection authority for depositing the first amount. At step 810, the payment interface 108 initiates deposit of the first amount (i.e., the withhold amount) and the payment amount in first and second accounts, respectively, such that the first account is of the tax collection authority and is linked to the retrieved account details, and the second account is of the vendor.

It will be apparent to a person having ordinary skill in the art that the method illustrated by the abovementioned flow chart 800 is applicable to B2C payments as well. In a B2C payment, a customer is the payer 102, a merchant is the first payee, and the tax-collection authority or any other indirect beneficiary is the second payee.

Thus, the payment interface 108 automatically initiates deposit of withhold amounts for purchases without requiring any human intervention. The deposit of the withhold amounts is based on proportion values automatically retrieved from a database that may be frequently updated. Further, the certificates indicating successful deposit of the withhold amounts are communicated to the payer (such as the payer 102) and other concerned entities. Hence, the payment interface 108 saves a merchant or a customer from a hassle of manually depositing the withhold amount and communicating a certificate to concerned entities. Further, the payment interface 108 serves as a constant check on all electronic transactions performed by merchants or customers, and hence withhold amounts are paid to concerned authorities without any hassle. Thus, the payment interface 108 enables smooth and efficient running of economies with a reduced number of violators slipping through the cracks.

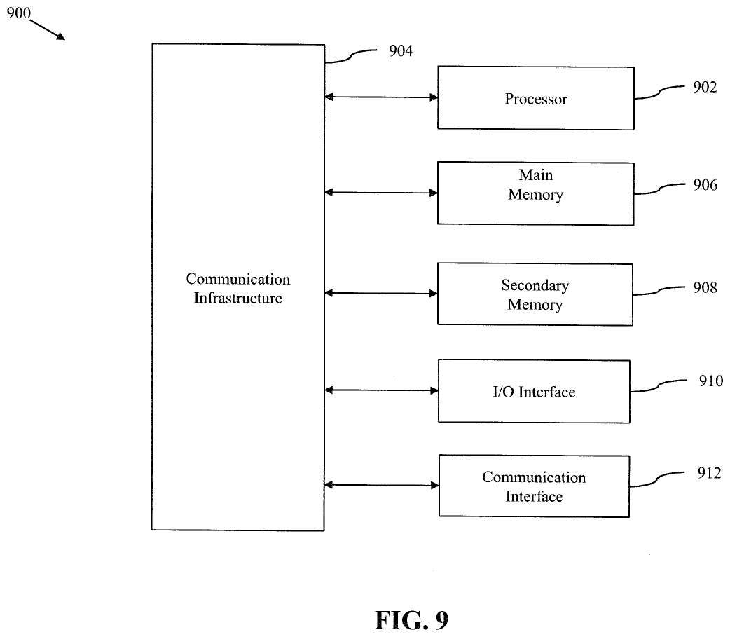

FIG. 9 represents a block diagram that illustrates system architecture of a computer system 900, in accordance with an embodiment of the present invention. An embodiment of the present invention, or portions thereof, may be implemented as computer readable code on the computer system 900. In one example, the payment interface 108, the database server 110, the acquirer servers 112, the payment network server 114, and the issuer server 116 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6A, 6B, and 6C, 7, and 8.

The computer system 900 includes a processor 902 that may be a special-purpose or a general-purpose processing device. The processor 902 may be a single processor, multiple processors, or combinations thereof. The processor 902 may have one or more processor cores. In one example, the processor 902 is an octa-core processor. Further, the processor 902 may be connected to a communication infrastructure 904, such as a bus, message queue, multi-core message-passing scheme, and the like. The computer system 900 may further include a main memory 906 and a secondary memory 908. Examples of the main memory 906 may include RAM, ROM, and the like. In one embodiment, the main memory 906 is the memory 204. The secondary memory 908 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 900 further includes an input/output (I/O) interface 910 and a communication interface 912. The I/O interface 910 includes various input and output devices that are configured to communicate with the processor 902. Examples of the input devices may include a keyboard, a mouse, a joystick, a touchscreen, a microphone, and the like. Examples of the output devices may include a display screen, a speaker, headphones, and the like. The communication interface 912 may be configured to allow data to be transferred between the computer system 900 and various devices that are communicatively coupled to the computer system 900. Examples of the communication interface 912 may include a modem, a network interface, i.e., an Ethernet card, a communication port, and the like. Data transferred via the communication interface 912 may correspond to signals, such as electronic, electromagnetic, optical, or other signals as will be apparent to a person skilled in the art. The signals may travel via a communication channel (not shown) which may be configured to transmit the signals to devices that are communicatively coupled to the computer system 900. Examples of the communication channel may include, but are not limited to, cable, fiber optics, a phone line, a cellular phone link, a radio frequency link, and the like.

Computer program medium and computer usable medium may refer to memories, such as the main memory 906 and the secondary memory 908, which may be a semiconductor memory such as a DRAM. These computer program mediums may provide data that enables the computer system 900 to implement the methods illustrated in FIGS. 6A, 6B, and 6C, 7, and 8. In an embodiment, the present invention is implemented using a computer implemented application, the computer implemented application may be stored in a computer program product and loaded into the computer system 900 using the removable storage drive or the hard disc drive in the secondary memory 908, the I/O interface 910, or communication interface 912.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 902 and a memory such as the main memory 906 and the secondary memory 908 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present invention provide, among other features, systems and methods for processing transactions. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for processing transactions, the method comprising:
receiving, by a payment interface, transaction details of a transaction initiated by a payer, wherein the transaction details include a payee identifier of a first payee and a payment amount;
accessing, by the payment interface, one or more databases based on the transaction details to retrieve account details of a second payee and a proportion value of the payment amount that is to be withheld for the second payee;
initiating, by the payment interface, withholding of a first part of the payment amount based on the retrieved proportion value; and
initiating, by the payment interface, deposit of the first part of the payment amount in a first account of the second payee that is linked to the retrieved account details.

2. The method of claim 1, wherein the transaction details further include account details of the first payee.

3. The method of claim 2, further comprising initiating, by the payment interface, a deposit of a remaining part of the payment amount in a second account of the first payee that is linked to the account details of the first payee.

4. The method of claim 1, further comprising communicating, by the payment interface, a certificate to the payer and the first payee indicating that the first part of the payment amount is successfully deposited in the first account.

5. The method of claim 1, wherein the payee identifier includes at least an identification code of the first payee and a type of service provided by the first payee.

6. The method of claim 1, wherein the payee identifier is a quick response (QR) code.

7. The method of claim 1, wherein the one or more databases include at least one look-up table or at least one ledger.

8. The method of claim 1, further comprising determining, by the payment interface, a schedule for depositing the first part of the payment amount in the first account.

9. The method of claim 8, further comprising communicating, by the payment interface, the determined schedule to the payer, the first payee, and the second payee.

10. A system for processing transactions, the system comprising:
a payment interface configured to:
receive transaction details of a transaction initiated by a payer, wherein the transaction details include a payee identifier of a first payee and a payment amount;
access one or more databases based on the transaction details to retrieve account details of a second payee and a proportion value of the payment amount that is to be withheld for the second payee;
initiate withholding of a first part of the payment amount based on the retrieved proportion value; and
initiate deposit of the first part of the payment amount in a first account of the second payee that is linked to the retrieved account details.

11. The system of claim 10, wherein the transaction details further include account details of the first payee.

12. The system of claim 11, wherein the payment interface is further configured to initiate a deposit of a remaining part of the payment amount in a second account of the first payee that is linked to the account details of the first payee.

13. The system of claim 10, wherein the payment interface is further configured to communicate a certificate to the payer and the first payee indicating that the first part of the payment amount is successfully deposited in the first account.

14. The system of claim 10, wherein the payee identifier includes at least an identification code of the first payee and a type of service provided by the first payee.

15. The system of claim 10, wherein the payee identifier is a quick response (QR) code.

16. The system of claim 10, wherein the one or more databases include at least one look-up table or at least one ledger.

17. The system of claim 10, wherein the payment interface is further configured to determine a schedule for depositing the first part of the payment amount in the first account.

18. The system of claim 17, wherein the payment interface is further configured to communicate the determined schedule to the payer, the first payee, and the second payee.

19. A method for processing business to business transactions, the method comprising:
receiving, by a payment interface, transaction details of a transaction initiated by a merchant, wherein the transaction details include a vendor identifier of a vendor and a payment amount;
accessing, by the payment interface, a first look-up table based on the vendor identifier to retrieve a proportion value of the payment amount that is to be withheld for a tax collection authority;
initiating, by the payment interface, withholding of a first amount from a merchant account of the merchant based on the retrieved proportion value;
accessing, by the payment interface, one of the first look-up table or a second look-up table to retrieve account details of the tax collection authority for depositing the first amount; and
initiating, by the payment interface, deposit of the first amount and the payment amount in first and second accounts, respectively, wherein the first account corresponds to the tax collection authority and is linked to the retrieved account details, and wherein the second account corresponds to the vendor.

20. The method of claim 19, further comprising communicating, by the payment interface, a certificate of the deposit of the first amount to the merchant, the vendor, and the tax collection authority by way of at least a short message service (SMS), an electronic mail (E-mail), or an application program interface (API).
